(19) United States
(12) Patent Application Publication
(10) Pub. No.: US 2015/0229633 A1
(43) Pub. Date: Aug. 13, 2015

(54) METHOD FOR IMPLEMENTING LOGIN CONFIRMATION AND AUTHORIZATION SERVICE USING MOBILE USER TERMINAL

(71) Applicants: Bohng Ju KIM, Namyangju-si (KR); Se Ung KIM, Seoul (KR); Kak HUH, Seoul (KR)

(72) Inventors: Bohng Ju KIM, Namyangju-si (KR); Se Ung KIM, Seoul (KR)

(73) Assignees: Bohng Ju KIM, Namyangju-si (KR); Kak HUH, Seoul (KR); Se Ung KIM, Seoul (KR)

(21) Appl. No.: 14/691,387

(22) Filed: Apr. 20, 2015

Related U.S. Application Data
(63) Continuation of application No. PCT/KR2013/005918, filed on Jul. 3, 2013.

(30) Foreign Application Priority Data
Oct. 19, 2012 (KR) 10-2012-0116681

(51) Int. Cl. H04L 29/06; H04L 29/08

(52) U.S. Cl. CPC H04L 63/083; H04L 67/02

(57) ABSTRACT

The present invention relates to a method of controlling a login access to a web server. The method enables a user to actively prevent an illegal login to a web server by transmitting a message indicating a login to the web server to a user terminal and blocking and restricting the re-login of the web server by the same user ID and password for a set access control time if a login to the web server by an illegal third-party is confirmed, and personal information to be efficiently protected by notifying the login to the web server and performing a forcible logout from the web server using only a user ID and a user terminal number.

### TECHNICAL FIELD

The present invention relates to a method of implementing login confirmation and authorization to a web servicer using a mobile device. More particularly, the present invention relates to a method of controlling a login access to a web server able to transmit a push message to a user terminal notifying a login access to a web server, and when an illegal access to the web server by a third party is confirmed, block and restrict re-login to the web server using the same user identifier (ID) and password for a set access control period, such that a user can actively prevent the third party from illegally logging in the web server. Using the user ID and the number of the user terminal, the method can efficiently protect personal information by notifying the web server of the login and performing a forced logout from the web server.

### BACKGROUND ART

Recently, as a variety of activities on the web has become possible in response to the development of the Internet environment, user authentication is frequently requested. For example, user authentication is requested when payment using a credit card or a mobile terminal is attempted to purchase a charged item on an online game shopping mall, or an amount of money is attempted to be transferred from a user account by Internet banking. In some cases, even an already-registered website requests a user to be confirmed as a true user when an access is attempted later.

According to methods widely used at present, in order to access the Internet and be provided with services from websites that a user intends to use, the user determines an identifier (ID) and a password for each website, and subsequently registers as a member by inputting a certain form of membership information requested by the website, such as social security number, address, telephone number, or so on. Afterwards, the user uses the website by logging in the website using the ID and the password.

However, a variety of reasons threatening security increases, and security incidents frequently occur due to the leaked IDs and passwords and the illegal use thereof. Due to personal information that is leaked online, various types of cybercrimes and property damage occur. Accordingly, security technologies for protecting information by preventing illegal acts, for example, preventing an unauthenticated person from accessing, reading, duplicating, making a fraudulent use of, or discarding personal information online, are continuously developed.

When the ID or password of a user set to a web server is illegally leaked, it is required to prevent a third party from illegally accessing the web server using the ID or password of the user. Related Art 1 prevents a third party from illegally accessing a web server by transmitting an authentication message containing an authentication number to a designated user terminal and receiving the authentication number input thereto in addition to the ID and password of the user.

In addition, Related Art 2 is another technology for preventing a third party from illegally accessing a web server using the ID or password of the user set to the web server when the ID or password of the user is illegally leaked. When a login to the web server using the ID and password of the user is attempted, Related Art 2 prevents the third party from illegally accessing the web server by transmitting a short message to a designated user terminal.

### DISCLOSURE

### Technical Problem

Although Related Art 1 as stated above can prevent the third party from illegally accessing the web server using the illegally leaked ID and password of the user, the user must have the user terminal in order to access the specific web server, and must additionally input the received authentication number into the web server, which are problematic.

In addition, according to Related Art 2, when a short message notifying the web server login is confirmed through the user terminal, the user must log in the specific web server through the user terminal or a PC that can access the Internet in order to forcibly log out the third party who has illegally logged in, which is inconvenient to the user. Furthermore, it is only possible to temporarily block the access to the specific web server by forcibly logging out the third party who has illegally logged in. Therefore, when the user forcibly logs out the third party who has illegally logged in, the third party can re-log in the web server and change the password or ID without permission, whereby the control over the user information becomes impossible.

The present invention has been made in order to overcome the above-stated problems, and an object of the present invention is to provide a method of controlling a login access to a web server able to transmit a push message to a designated user terminal notifying a login access to a web server using the ID and password of the user. When a third party has illegally logged in the web server, the third party can be forcibly logged out from the web server.

Another object of the present invention is to provide a method of controlling a login access to a web server able to, when an illegal access to a web server by a third party is confirmed, block and restrict a re-login to the web server using the same user ID and password for a set access control period in response to a logout message received from the designated user terminal.

A further object of the present invention is to provide a method of controlling a login access to a web server able to advantageously protect user information by controlling accesses to a web server using only the user ID and the number of the user terminal mapped to the user ID.

A further another object of the present invention is to provide a method of controlling a login access to a web server able to protect a plurality of set web servers from being illegally accessed by a third party by transmitting login information about the plurality of set web servers.

### Technical Solution

In order to realize the foregoing objects, a method of controlling a login access to a web server. The method includes: receiving, at an access control management server, a login information message including a user ID from a web server registered in the access control management server when a login to the web server using the user ID is performed; transmitting, at the access control management server, a login notification message to a user terminal mapped to the user ID notifying the login to the web server; and when a login reject message is received from the user terminal in response to the login notification message, transmitting, at the access control management server, a logout message to the web server, the logout message blocking the login to the web server using the user ID.

Here, when the logout message is received from the access control management server, the web server may log out the login to the web server using the user ID.

When the logout message is received, the web server may restrict a re-login to the web server using the user ID for a set access control period.

The access control management server may receive information about the set access control period from the user terminal, the information about the set access control period being contained in the logout message.

When the login notification messages are received according to the web servers registered in the access control management server, the access control management server may store and manages login information of the web servers by classifying the login information according to the web servers. When a login information request message for one web server selected from among the web servers registered in the access control management server is received from the user terminal, the access control management server may provide the login information message containing login information for a unit period of the selected web server to the user terminal.

It is preferable that, when a login reject message for the selected web server is received from the user terminal in response to the login information message, the access control management server transmits a logout message to the web server, causing a login access to the selected web server using the user ID to be blocked.

It is preferable that the login notification message transmitted from the access control management server to the user terminal is in the form of a push message.

### Advantageous Effects

The method of controlling a login access to a web server according to the present invention has a variety of effects as follows:

First, the method of controlling a login access to a web server according to the present invention can transmit a push message to a designated user terminal notifying a login access to a web server using the ID and password of the user. When a third party has illegally logged in the web server, the third party can be forcibly logged out from the web server. In addition, since information about the login is transmitted in the form of a push message, the push message can be disregarded in the case of a legal login to the web server, thereby reducing the burden of the user to manage logins to the web server.

Second, when an illegal access to a web server by a third party is confirmed, the method of controlling a login access to a web server according to the present invention can block and restrict a re-login to the web server using the same user ID and password for a set access control period in response to a logout message received from the designated user terminal. It is therefore possible to block the re-login to the web server for the set access control period only when the logout is caused by the logout message, thereby preventing the web server from being secondarily accessed and operated in an illegal manner.

Third, the method of controlling a login access to a web server according to the present invention can notify an illegal login to a web server and perform a forced logout from the web server using a login information message containing a user ID and a reference of the web server; a login notification message containing the user ID, login time information, and the reference of the web server; and a logout message containing the user ID and the reference of the web server. It is therefore possible to minimize the disclosure of user information when the access control management server is cracked, and prevent the web server from being illegally logged in.

Fourth, the method of controlling a login access to a web server according to the present invention provides the user terminal with real-time information about logins to a plurality of set web servers, such that the user can monitor the real-time login state of the plurality of web servers to which he/she has registered, and prevent a specific web server from being illegally accessed by a third party.

Fifth, according to the method of controlling a login access to a web server according to the present invention, the user requests a web server for a login notification service, and the web server transmits the login state of the user who has requested for the login notification service to the access control management server. The web server operator transmits information about the login state to the access control management server without constructing additional equipment. It is possible to prevent a third party from logging in the web server based on the login state, thereby improving the reliability of the web server of the user.

### DESCRIPTION OF DRAWINGS

FIG. 1 is a block diagram illustrating an access control system according to the present invention;

FIG. 2 is a functional block diagram illustrating an access control management server according to the present invention;

FIG. 3 is a flow diagram illustrating messages transmitted and received for login to a web server in the access control management server according to the present invention;

FIG. 4 is a flow diagram illustrating messages transmitted and received when the access control management server according to the present invention requests the login information of the web server;

FIG. 5 illustrates an example of the user interface of an access management application according to the present invention; and

FIG. 6 illustrates an example of the user interface of the access management application for which a web server is registered in the access control management server.

### BEST MODE

Reference will now be made in detail to a method of controlling a login access to a web server according to the present invention in conjunction with the accompanying drawings.

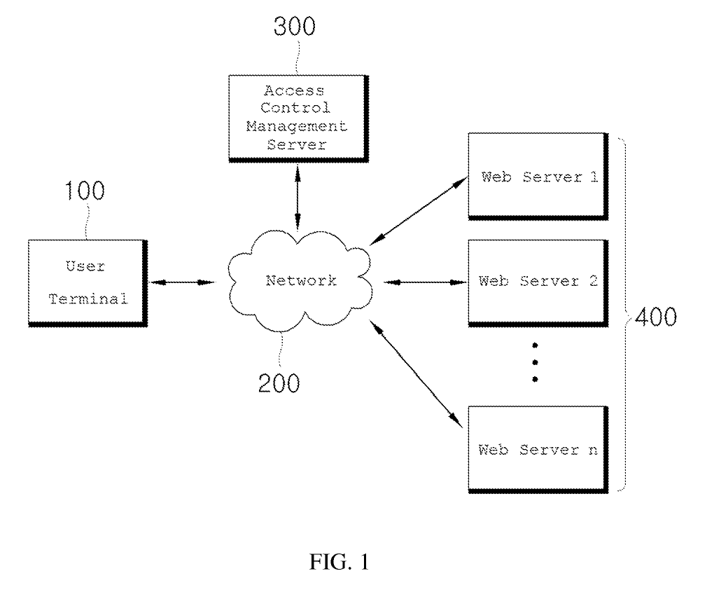

FIG. 1 is a block diagram illustrating an access control system according to the present invention.

Describing in more detail with reference to FIG. 1, a user terminal 100, an access control management server 300, and a plurality of web servers 400 providing web services are connected to a wired/wireless network 200. Here, the user terminal 100 is a terminal able to transmit or receive data to or from the access control management server 300 through the network 200. For example, the user terminal may be implemented as a smartphone.

The web servers 400 are servers that provide web services to a personal computer (not shown) or the user terminal 100 of a user. The user registers as a member in each of the web servers 400 by providing membership information in a certain form that the web server 400 requests, an identifier (ID), and a password to the web server 400, and uses web services that the web server 400 provides by logging in the web server 400 by inputting the ID and the password using a personal computer (PC) or the user terminal 100. Here, the web services provided by the web server 400 may include a portal service, an online game, or the like, which may vary according to fields to which the present invention is applied.

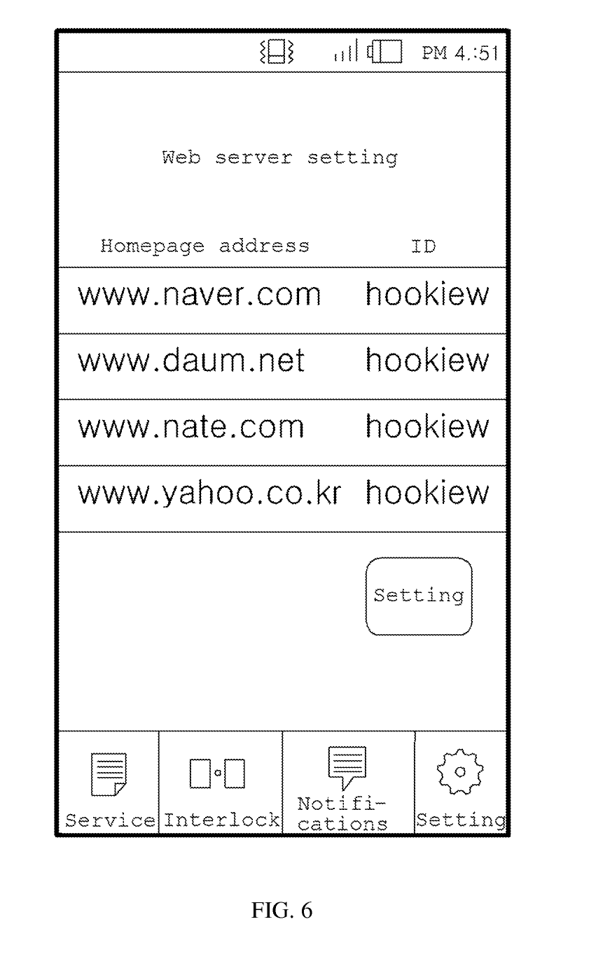

The user accesses the access control management server 300 using the user terminal 100, downloads and executes a control management application provided by the access control management server 300 to the user terminal 100, and registers a web server, for which the login notification service will be requested, in the access control management server 300. FIG. 6 illustrates an example of the user interface of the access management application for which a web server is registered in the access control management server. As illustrated in FIG. 6, the references and IDs of the web servers to be controlled and managed through the access management application are input.

In the case of a login to a specific one of the web servers using the ID and password of the user, the web server determines whether or not the login notification service is requested by the user ID, and when the login notification service is requested by the user ID, transmits login information to the access control management server 300.

The access control management server 300 transmits the login information to the user terminal, and when it is determined based on the login information that a third party has logged in the web server 400 using the ID and password without permission, the user requests the access control management server 300 for the logout of the third party from the web server 400. When the request for the logout from the web server 400 is received from the user terminal 100, the access control management server 300 requests the web server 400 to forcibly log out the third party who has logged in using the user ID and password.

It is preferable that the web server 400 restricts a re-login to the web server using the same user ID and password for a set access control period when the third party using the user ID and password is forcibly logged out at the request of the access control management server 300.

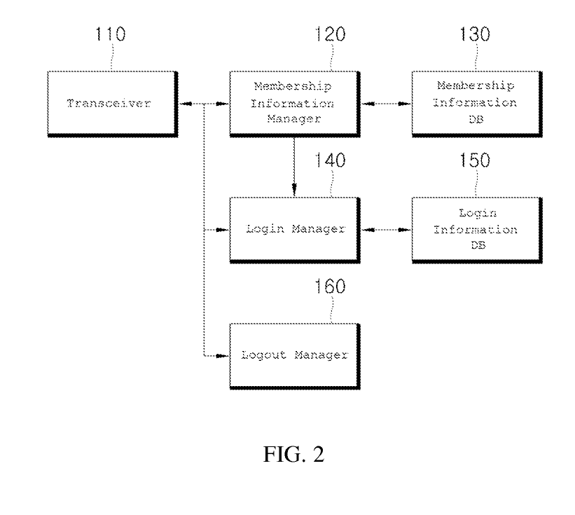

FIG. 2 is a functional block diagram illustrating the access control management server according to the present invention.

Describing in more detail with reference to FIG. 2, a transceiver 110 provides the access management application to the PC or the user terminal 100 connected to the network 200, and receives input management membership information through the access management application. The management membership information includes personal information, such as the name, gender, address, and email address of the user, the contact information of the user terminal, the references of the web servers mapped in the user terminal for the login notification service, and the user IDs registered in the web servers. According to fields to which the present invention is applied, the management membership information includes the contact information of the user terminal, the references of the web servers mapped to the user terminal that are supposed to be provided with the login notification service, and the user IDs registered in the web servers except for the personal information. Here, the reference of each of the web servers indicates information with which the web server is identified, and may be, for example, the name or Internet protocol (IP) address of the web server. A membership information manager 120 stores the management membership information input through the transceiver 110 in a membership information database (DB) 130 by classifying the web servers, for which the login notification service is requested and registered, according to users or the contact information of user terminals.

The login manager 140 receives a login information message from the web server through the transceiver 110, and determines whether or not the login notification service is requested for the web server that has transmitted the login information message by determining whether or not the management membership information includes a user ID the same as the user ID in the login information message based on the user ID in the received login information message and the user IDs registered and stored in the membership information DB 130. When the web server that has transmitted the login information message is a web server for which the login notification service is requested, the login manager 140 stores the login time information of the web server contained in the login information message in a login information database (DB) 150. At the same time, the login manager 140 generates a login notification message, and transmits the generated login notification message in the form of a push message to the contact information of the user terminal mapped to the management membership information. When the access control management server receives the login information message, the login notification message in the form of the push message is automatically generated and transmitted to the user terminal.

When a login reject message is received from the user terminal 100 through the transceiver 110, a logout message causing a forced logout from the web server is generated, and is transmitted to the web server.

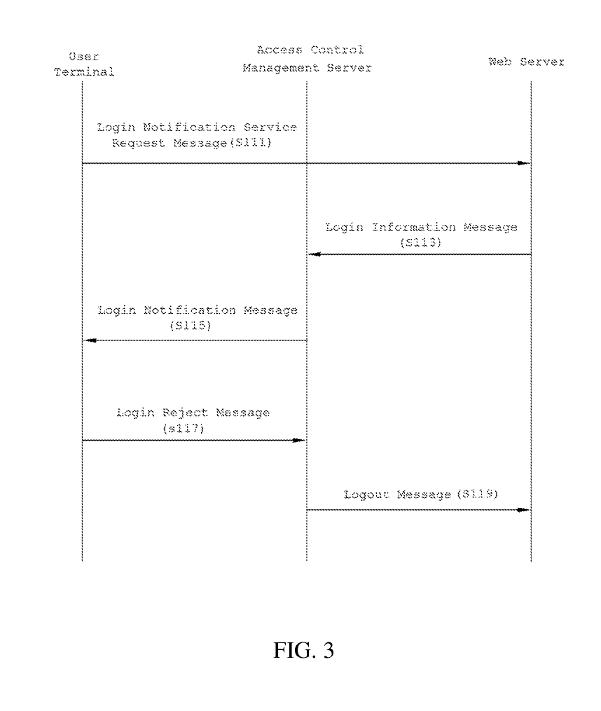

FIG. 3 is a flow diagram illustrating messages transmitted and received for login to a web server in the access control management server according to the present invention.

Describing in more detail with reference to FIG. 3, at S111, the user terminal transmits a login notification service request message to a web server in order to use the login notification service. According to fields to which the present invention is applied, the login notification service may be requested using the user terminal 100 or a PC that can access the web server 400 through the network 200 and transmit or receive data to or from the web server 400. The request for the login notification service indicates “to transmit login information to the access control management server when a login to the web server using the user ID and password occurs.” The user IDs of the users who have requested the login notification service are registered and stored in the web server.

In the case of a login to the web server using the user ID and password, the web server determines whether or not the login notification service has been requested by the user ID. When the login notification service is requested by the user ID, at S113, the web server generates a login information message and transmits the login information message to the access control management server. The login information message contains the user ID by which the login to the web server is performed or visual information about the login.

At S115, when the login information message is received, the access control management server generates a login notification message in the form of a push message, and transmits the login notification message to the user terminal, notifying the user terminal of the login. Describing in more detail, the access control management server extracts the user ID from the login information message, and searches the management membership information of the access control management server for the same ID. When a user ID the same as the user ID extracted for the web server is present in the management membership information of the access control management server as a result of the search, a login notification message is transmitted to the user terminal based on the contact information of the user terminal mapped to the user ID in the management membership information.

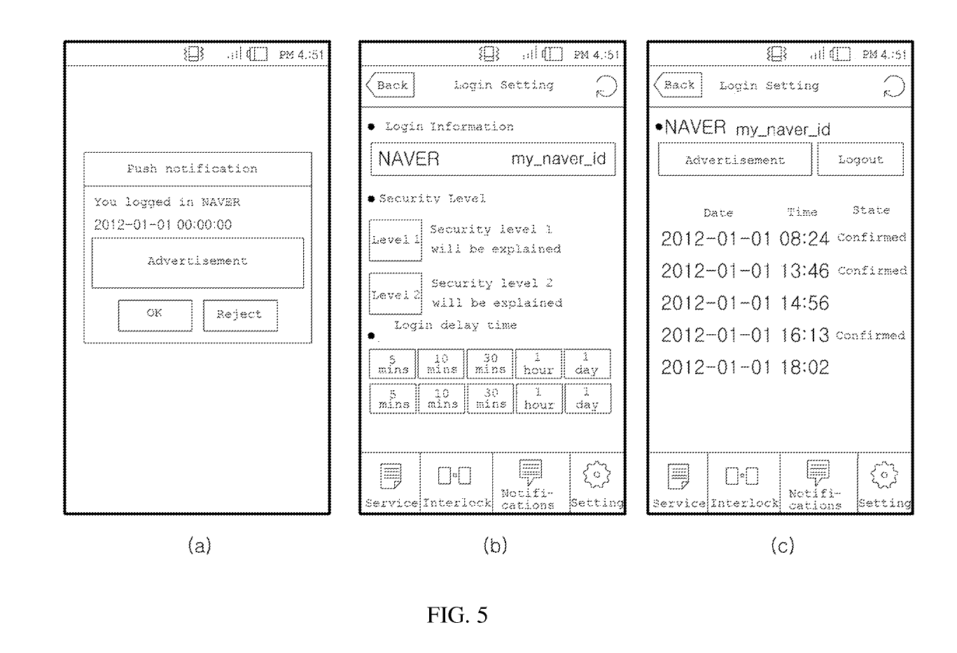

Part (a) of FIG. 5 is an example of the login notification message. As illustrated in part (a) of FIG. 5, the login notification message is transmitted in the form of a push message. The login notification message includes the name of the web server, a button for confirming the login to the web server, and a button for rejecting the login to the web server.

When the user has logged in the web server by himself/herself or a third party allowed by the user has logged in the web server, the user uses web services provided by the web server by continuously accessing the web server by pressing the confirmation button or disregarding the login notification message. However, when a third party has illegally accessed the web server by inputting the user ID and password, the user presses the login reject button, thereby inputting a user instruction to perform a forced logout from the web server. In response to the input user instruction, at S117, the user terminal generates a login reject message, and transmits the generated login reject message to the access control management server.

Preferably, when the user terminal generates the login reject message for performing the force logout from the web server, an access control period during which a re-login to the web server using the same user ID and password is blocked and restricted may be set, and the generated access control period may be contained in the login reject message. As illustrated in part (b) of FIG. 5, a user interface allowing the user to set the access control period is activated by the access management application operating in the user terminal. The user sets the access control period during which the re-login to the web server is blocked and restricted when generating the login reject message. More preferably, different access control periods may be set according to the web servers.

When the login reject message is received, at S119, the access control management server generates a logout message causing a force logout from the web server, and transmits the generated logout message to the web server. It is preferable that the logout message contains information about the user ID and the access control period. The web server extracts the user ID from the logout message, performs a forced logout of the extracted user ID from the web server, and blocks and restricts the re-login during the access control period.

The method of controlling a login access to a web server according to the present invention prevents the third party who has illegally accessed the web server from re-logging in the web server using the same user ID and password after being forcibly logged out from the web server by setting the access control period and blocking and restricting the re-login to the web server using the same ID and password during the access control period. This prevents the third party from changing the ID or password of the user without permission by re-logging in the web server, which would otherwise obstruct the legal login of the user in the web server. In addition, the set control period is a time period during which the user can request the operator of the web server to reissue a password and log in the web server using the reissued password.

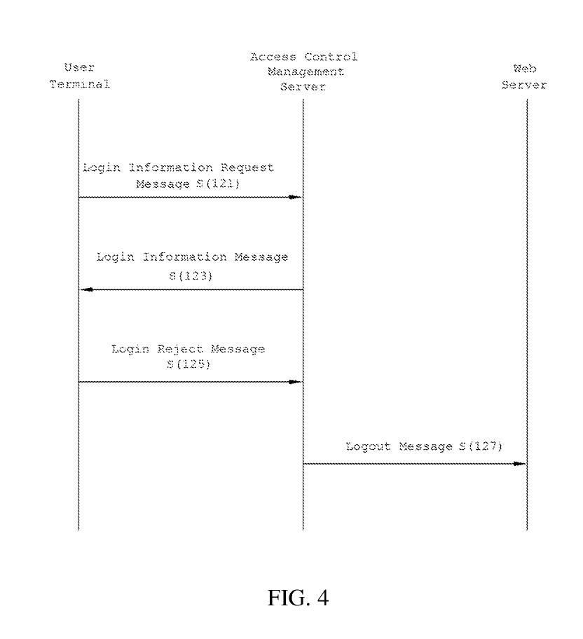

FIG. 4 is a flow diagram illustrating messages transmitted and received when the access control management server according to the present invention requests the login information of the web server.

Describing in more detail with reference to FIG. 4, at S121, the user terminal generates a login information request message as an intention to request the login information of the web server for which the user requested a login notification service, and transmits the login information request message to the access control management server. The login information request message contains the reference of the web server, the login information of which is requested, and the user ID.

At S123, the access control management server generates a login information message containing the login information of the web server corresponding to the reference of the web server extracted from the login information request message, and transmits the generated login information message to the user terminal. The access control management server extracts the login information of the web server mapped to the user ID during a unit period from the login information DB based on the web server reference and the user ID contained in the login information request message, and generates the login information message containing the extracted login formation during the unit period. Here, the unit period indicates a unit period of time during which the login information of the web server is provided. The user may set the unit period by one day, one week, or 10 days through the access management application. The login information message contains information about entire points of time at which the web server have been logged in during the set unit period.

When the information of an illegal login to the web server by a third party is confirmed based on the login information message, at S125, a login reject message causing a forced logout from the web server is generated, and the generated login reject message is transmitted to the access control management server. It is preferable that the generated login reject message contains information about the access control period. When the login reject message is received, at S127, the access control management server generates a logout message causing a forced logout of the user ID and password from the web server, and transmits the logout message to the web server.

Part (c) of FIG. 5 illustrates an example of the login information message. As illustrated in part (c) of FIG. 5, the login information of the web server for a unit period, i.e. for one day, is presented. An illegal login to the web server by a third party at 18:02 is confirmed based on state information in the login information. In this case, a user instruction causing a forced logout from the web server is input through the user interface activated by the access management application operating in the user terminal, and a login reject message is generated in response to the input user instruction.

The method of controlling a login access to a web server according to the present invention transmits the login notification message in the form of a push message in order to reduce the burden of the user to manage the logins to the web server. However, it is not confirmed whether or not the login notification message in the form of a push message has been transmitted to the user terminal without an error. In order to overcome this drawback, the user can manage the logins to the web server by requesting the login information of the registered web server at any time through the access management application operating in the user terminal.

The above-described embodiments of the present invention can be recorded as programs that can executed by a computer, and can be realized in a general purpose computer that executes the program using a computer readable recording medium.

Examples of the computer readable recording medium include a magnetic storage medium (e.g. a floppy disk or a hard disk), an optical recording medium (e.g. a compact disc read only memory (CD-ROM) or a digital versatile disc (DVD)), and a carrier wave (e.g. transmission through the Internet).

While the present invention has been described with reference to the certain exemplary embodiments shown in the drawings, these embodiments are illustrative only. Rather, it will be understood by a person skilled in the art that various modifications and equivalent other embodiments may be made therefrom. Therefore, the true scope of the present invention shall be defined by the concept of the appended claims.

1. A method of controlling a login access to a web server, comprising:
receiving, at an access control management server, a login information message containing a user identifier from a web server registered in the access control management server when a login to the web server using the user identifier is performed;
transmitting, at the access control management server, a login notification message to a user terminal mapped to the user identifier notifying the login to the web server; and
when a login reject message is received from the user terminal in response to the login notification message, transmitting, at the access control management server, a logout message to the web server, the logout message blocking the login to the web server using the user identifier.

2. The method according to claim 1, wherein, when the logout message is received from the access control management server, the web server logs out the login to the web server using the user identifier.

3. The method according to claim 2, wherein, when the logout message is received, the web server restricts a re-login to the web server using the user identifier for a set access control period.

4. The method according to claim 3, wherein the access control management server receives information about the set access control period from the user terminal, the information about the set access control period being contained in the logout message.

5. The method according to claim 3, wherein,
when the login notification messages are received according to the web servers registered in the access control management server, the access control management server stores and manages login information of the web servers by classifying the login information according to the web servers, and
when a login information request message for one web server selected from among the web servers registered in the access control management server is received from the user terminal, the access control management server provides the login information message containing login information for a unit period of the selected web server to the user terminal.

6. The method according to claim 5, wherein, when a login reject message for the selected web server is received from the user terminal in response to the login information message, the access control management server transmits a logout message to the web server, causing a login access to the selected web server using the user identifier to be blocked.

7. The method according to 1, wherein the login notification message transmitted from the access control management server to the user terminal is in a form of a push message.

8. The method according to 2, wherein the login notification message transmitted from the access control management server to the user terminal is in a form of a push message.

9. The method according to 3, wherein the login notification message transmitted from the access control management server to the user terminal is in a form of a push message.

10. The method according to 4, wherein the login notification message transmitted from the access control management server to the user terminal is in a form of a push message.

11. The method according to 5, wherein the login notification message transmitted from the access control management server to the user terminal is in a form of a push message.

12. The method according to 6, wherein the login notification message transmitted from the access control management server to the user terminal is in a form of a push message.
